(19) United States
(12) Patent Application Publication
(10) Pub. No.: US 2008/0084498 A1
(43) Pub. Date: Apr. 10, 2008

(54) CAMERA IRIS APPARATUS AND METHOD

(75) Inventors: FAN HE, GURNEE, IL (US); MICHAEL W. FRENZER, PALATINE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/538,649

(22) Filed: Oct. 4, 2006

(51) Int. Cl. H04N 5/238

(52) U.S. Cl. 348/363

(57) ABSTRACT

Disclosed are methods and devices for the irises of cameras. A non-mechanical or electro-optical camera iris includes a controlled material that is configured to change from substantially transparent to substantially opaque by changing the state of the controlled material to effectively adjust the size of the central window of the iris. Accordingly, the described electro-optical iris would add little or no additional bulk to a small mobile communication device camera. The controlled material can be electrically controlled or thermally controlled. The controlled material can be a set of separately controllable areas substantially surrounding the central window. The set can have an ordering from outer to inner so that outer separately controllable areas in the set substantially surround inner separately controllable areas in the set. Accordingly, by changing the opacity of the outer area from transparent to opaque, the size of the central window of the adjustable aperture is reduced.

### FIELD

Disclosed are camera iris apparatuses and methods, and more particularly electro-optically adjustable camera iris apparatuses and methods that are non-mechanical in operation.

### BACKGROUND

The makers of mobile communication devices, including those of cellular telephones, are increasingly adding functionality to their devices. For example, cellular telephones include features such as still and video cameras, video streaming, and two-way video calling. Users may capture still or video images on their wireless communication devices and transmit a file to a recipient via a network.

While there is a trend toward the inclusion of more features and improvements for current features, there is also a trend toward smaller mobile communication devices. As mobile communication device technology has continued to improve, the devices have become increasingly smaller. Fewer and/or smaller hardware and software components are therefore desirable when adding new features and making improvements to the current features in the smaller devices. Fewer hardware components may provide a cost benefit to the consumer.

The size constraints of cellular telephones have restricted the use of diaphragms with adjustable apertures, or irises, in their cameras. A mechanical camera iris is a diaphragm having a variable opening for a camera lens to alter the amount of light being admitted as well as to adjust the depth of field available for the image. A mechanical iris would add too much bulk to a mobile communication device camera, and therefore, manufacturers do not include adjustable irises, in particular, in cellular telephones.

U.S. Patent Application Publication No. 2005/0243237 describes a light-emitting apparatus, including an LED element and a liquid crystal layer that is transparent in both its active and inactive states. Ringlike electrodes adjacent the liquid crystal layer are energized to modify its refractive index so that it behaves like a convex lens to broaden and narrow the directions of light emitted by the apparatus. Since the liquid crystal layer is always transparent, it cannot function as an adjustable iris.

### BRIEF DESCRIPTION OF THE DRAWINGS

FIG. 1 depicts in side view a mobile communication device 102 including a camera having an electro-optical iris as described in detail below;

FIG. 2 illustrates an embodiment of a camera's adjustable aperture through which light passes that is a non-mechanical or electro-optical iris;

FIG. 3 depicts another embodiment of a set of separately controllable areas that can substantially surround the center or central window;

FIG. 4 is a flow diagram of an embodiment of a method in a camera with a camera aperture as described herein;

FIG. 5 depicts side view of an embodiment of a controlled material aperture structure having a layer of an electro-chromic material 502 such as switchable mirror;

FIG. 6 depicts side view of an embodiment of a controlled material aperture structure having a layer of an electro-chromic material 602 such as supertwist nematic material;

FIG. 7 shows an analog circuit according to an embodiment in communication with contacts of the controlled material aperture structure; and

FIG. 8 shows a digital circuit according to an embodiment in communication with contacts of the controlled material aperture structure.

### DETAILED DESCRIPTION

Disclosed are methods and devices for non-mechanical irises of cameras. A non-mechanical or electro-optical camera iris includes a controlled material that is configured to change from substantially transparent to substantially opaque by changing the state of the controlled material to effectively adjust the size of the central window of the iris. Accordingly, the described electro-optical iris would add little or no additional bulk to a small mobile communication device camera, and therefore, manufacturers may be inclined to include adjustable apertures, in particular, in cellular telephones. The controlled material can be electrically controlled or thermally controlled. The controlled material can be a set of separately controllable areas substantially surrounding the central window. The set can have an ordering from outer to inner so that outer separately controllable areas in the set substantially surround inner separately controllable areas in the set. For example, the controllable areas can form rings around the center window. All other configurations are also within the scope of this discussion. Accordingly, by changing the opacity of different areas of the iris from transparent to opaque, the size of the central window of the adjustable aperture is reduced.

A camera with an adjustable aperture or iris can have a wider dynamic range than one without an adjustable iris. It is understood that a camera is a still camera, a video camera, or a video/still combination camera. A typical camera in a cellular telephone can accommodate an input light intensity ranging from 5 lux to 110 k lux (5 to 110000 lux). With an adjustable aperture or iris as described herein, a cellular telephone camera can accommodate an input light intensity of more than 160 k lux. Such input light intensities may be found in outdoor settings including desert or snow.

A camera with a fixed focus lens commonly has a focus range from 50 cm to infinity. A camera with an iris or adjustable aperture can have a greater depth of focus or depth of field over a camera without an adjustable aperture or iris. This advantage can occur whenever there is adequate lighting such that the adjustable iris can be set to anything less than a fully open aperture. Under this condition the depth of focus improves with smaller aperture size due to the reduction in aberration. Consequently a user of a cellular telephone camera having an adjustable aperture can achieve an expanded depth of field, for instance from 12 cm to infinity under proper lighting conditions versus a camera without an adjustable aperture that may be limited to a focus range of only 50 cm to infinity.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

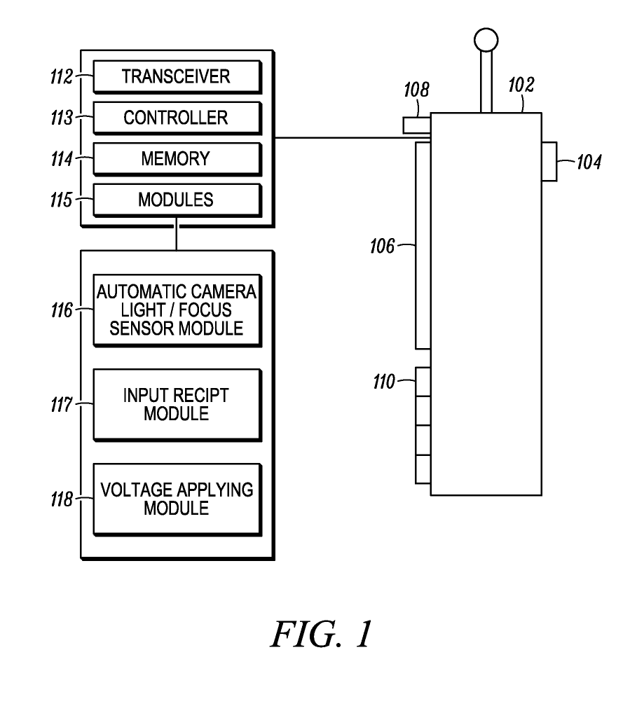

FIG. 1 depicts in side view a mobile communication device 102 including a camera 104 having a non-mechanical or electro-optical iris as described in detail below. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). It is understood that while FIG. 1 depicts a mobile communication device, the described electro-optical iris may be used in any camera, including stand-alone cameras or cameras incorporated into devices other than a mobile communication device.

FIG. 1 illustrates that camera 104 may be on the back side of a cellular telephone. The camera 104 may point away from the back of the device. In this manner, when taking a still photograph, the user may view on the display 106 a digitally reproduced image of the user's object, much like the view screen of a stand alone digital camera. In a mobile communication device the still camera 104 and video camera 108 may point in opposite directions from the device 102. The device may further include a keypad and other controls 110 for receiving input.

To transmit and receive images and other communication the device 102 can include a transceiver 112. The device further includes a processor or controller 113 and memory 114. In conjunction with the processor 113, the modules 115 can carry out certain processes of the methods as described below. The modules can include an automatic camera light and/or focus sensor module 116, an input receiving module 117 and a voltage applying module 118. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

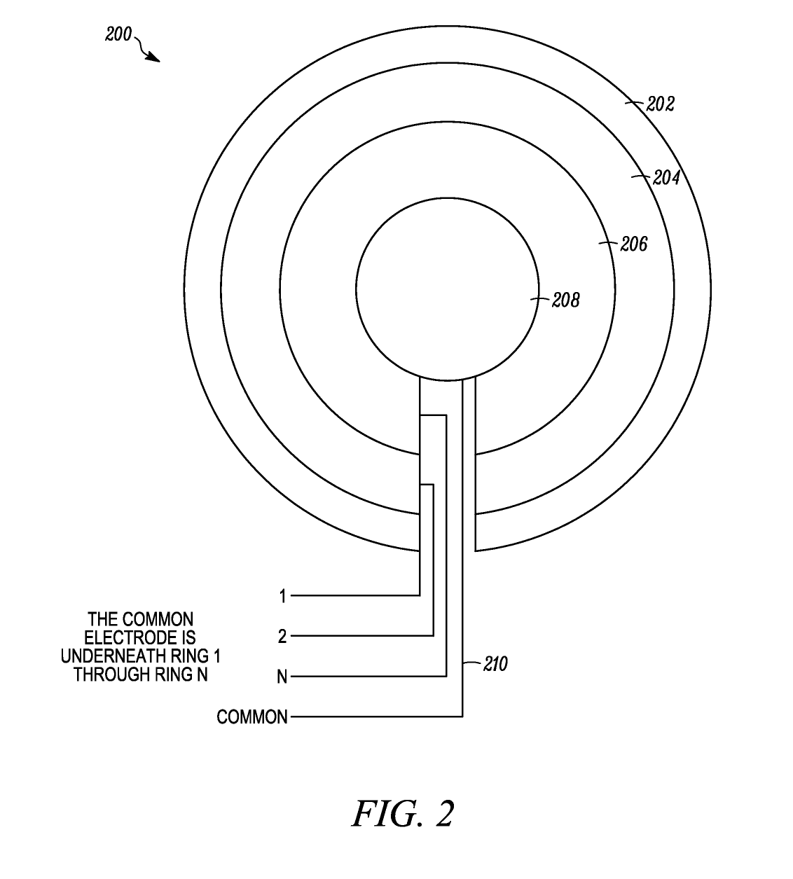

FIG. 2 illustrates an embodiment of a camera's adjustable aperture through which light passes that is a non-mechanical or electro-optical iris. A camera may receive input from the user via input receiving module 117, and/or have automatic features for focusing and light adjustments via an automatic camera light and/or focus sensor module 116. In any event, the adjustable aperture 200 has a maximum size that may depend on the camera that can define a central window. FIG. 2 depicts three rings 202, 204 and 206 of controlled material around the center 208. In a first mode, the three rings can be transparent. In another mode, the ring 202 changes its state from transparent to opaque, effectively reducing the size of the central window. In another mode, the ring 204 changes its state from transparent to opaque, effectively reducing the size of the central window more. In yet another mode, the ring 206 changes its state from transparent to opaque, effectively reducing the size of the central window even more. When the three rings 202, 204 and 206 are opaque, light can be transmitted through the center 208. The size of the central window is limited by controlling the opacity of the controlled material that circumscribes the center 208. It is understood that in this description, transparent and opaque can refer to substantially transparent and substantially opaque. Other references to substantial characteristics are likewise considered.

In the reverse situation, the three rings can change from opaque to transparent. In a first mode, the three rings can be opaque so that the light can be transmitted through a central window the size of the center 208. In another mode, the ring 206 changes its state from opaque to transparent, effectively increasing the size of the central window to include the third ring 206 and the center 208. In another mode, the ring 204 changes its state from opaque to transparent, effectively increasing the size of the central window more to include both the second ring 204 and the third ring 206 and the center 208. In yet another mode, the ring 206 changes its state from opaque to transparent, effectively increasing the size of the central window even more. When the three rings 202, 204 and 206 are transparent, light can be transmitted through the entire size of the aperture 200, thus the central window can include the three rings 202, 204 and 206 and the center 208. Accordingly, the size of the central window is adjustable.

A layer of controlled material can include a set of separately controllable areas that may be in any shape. A set of separately controllable areas can substantially surround the center 208 forming a central window. The center 208 can be a substantially transparent window or area without controlled material over the transparent area. While three rings 202, 204 and 206 are shown in FIG. 1, there may be more or fewer rings. In one embodiment, a ring has a width of approximately 0.2 millimeter. The rings may surround a central area that may be off-centered as well. The transparent area can be to one side or the other. The transparent area can be any configuration so long as the view for the image passes through the transparent area.

In the case where the rings surround the center, the set can have an ordering from inner to outer and/or outer to inner so that outer separately controllable areas 202 in the set substantially surround inner separately controllable areas 204 and 206 in the set. In the embodiment shown in FIG. 1 the center 208 or central window can be substantially circular, and the set of separately controllable areas that are rings may be substantially concentric with the center. The contacts 210 are configured to be coupled with a circuit to provide voltage to the rings or controlled material segments or separately controllable areas. A bistable material would be beneficial so that there would be no need to keep a non-zero voltage applied to the material to maintain its state.

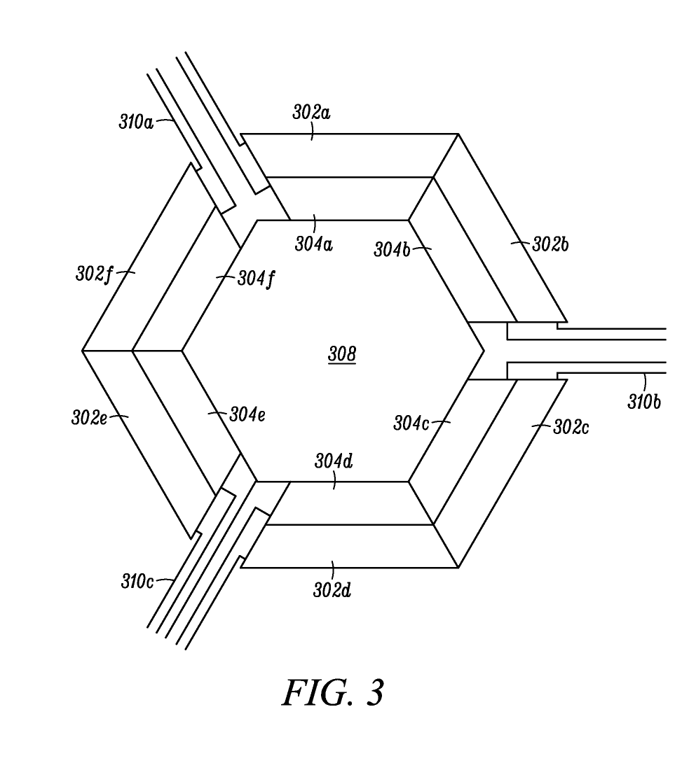

FIG. 3 depicts another embodiment of a set of separately controllable areas and a center 308. In one embodiment, the set of separately controllable areas includes substantially polygonal segments. A plurality of segments 302a-f can surround segments 304a-f which can circumscribe the center 308. Contacts 310a, 310b, and 310c are configured to be coupled with a circuit to provide voltage to the controlled material segments. It is understood that the described electro-optical iris can include any configuration of the segments of controlled material. For example, the controlled material segments may be configured in a spiral configuration, rather than in a concentric configuration as shown in FIG. 3. Moreover, one or more edges of the substantially polygonal segments may be curved.

As discussed above, the controlled material is configured to change from substantially opaque to substantially transparent by changing the state of the controlled material to effectively increase the size of the central window. The controlled material includes an electrically controlled material or thermally controlled material.

The state of the electrically controlled material is controlled by an amplitude of a voltage or by addressing through digital gates as will be described in more detail below. The controlled material is selected from the group consisting of electrically switchable mirror material, polymer liquid crystal material, cholesteric liquid crystal material, twisted nematic (TN) liquid crystal material, and supertwist nematic (STN) liquid crystal material. It is understood that any suitable material may be used as a controlled material. The controlled material can be opaque by reflection and/or by absorption.

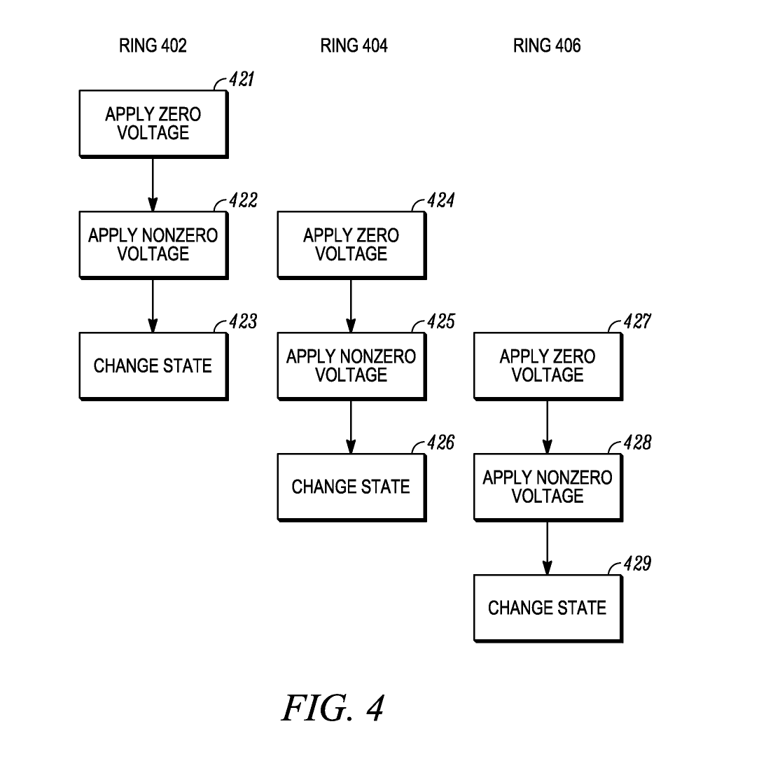

FIG. 4 is a flow diagram of a method in a camera with a camera aperture having a size, the method for changing the size of the camera aperture, the camera aperture having a transparent window of predetermined size and having electrically controlled material proximal the transparent window. For the outer ring 402 the method includes applying a first voltage 421 that can be a zero voltage to the electrically controlled material so that the electrically controlled material is substantially transparent and consequently the size of the aperture is that of the predetermined size. Then for the outer ring 402, the method includes applying a second non-zero voltage 422 to the electrically controlled material to change the state 423 of the electrically controlled material so that the electrically controlled material is substantially opaque to limit the size of the aperture to less than the predetermined size to realize an aperture adjustment to limit the size of the aperture. As mentioned above, the reverse sequence can occur where the controlled material is configured to change from substantially opaque to substantially transparent by changing the state of the controlled material to effectively increase the size of the central window.

The flow diagram of FIG. 4 further illustrates the method of an inner ring 404 that includes applying a first voltage 424 that can be a zero voltage to the electrically controlled material so that the electrically controlled material is substantially transparent and consequently the size of the aperture is that of the predetermined size. Then for an inner ring 404, the method can include applying a second non-zero voltage 425 to the electrically controlled material to change the state 426 of the electrically controlled material so that the electrically controlled material is substantially opaque to limit the size of the aperture to less than the predetermined size to realize an aperture adjustment to further limit the size of the aperture. The reverse sequence can occur where the controlled material is configured to change from substantially opaque to substantially transparent by changing the state of the controlled material to effectively increase the size of the central window.

The flow diagram of FIG. 4 still further illustrates the method of an inner ring 406 that includes applying a first voltage 427 that can be a zero voltage to the electrically controlled material so that the electrically controlled material is substantially transparent and consequently the size of the aperture is that of the predetermined size. Then for an inner ring 406, the method can include applying a second non-zero voltage 428 to the electrically controlled material to change the state 429 of the electrically controlled material so that the electrically controlled material is substantially opaque to limit the size of the aperture to less than the predetermined size to realize an aperture adjustment to further limit the size of the aperture. The reverse sequence can occur where the controlled material is configured to change from substantially opaque to substantially transparent by changing the state of the controlled material to effectively increase the size of the central window.

As illustrated in FIG. 3, the described electro-optical iris can include any configuration of the segments of controlled material, including substantially polygonal segments that can be, for example, substantially trapezoidal. It is understood that the order in which the controlled material segments received a non-zero voltage or thermal energy can be any order. Accordingly, in any suitable configuration, the describe electro-optical iris could add little or no additional bulk to a small mobile communication device camera, and therefore, manufacturers may be inclined to include adjustable apertures, in particular, in cellular telephones, thus increasing the range for the depth of focus and range for the sensed light.

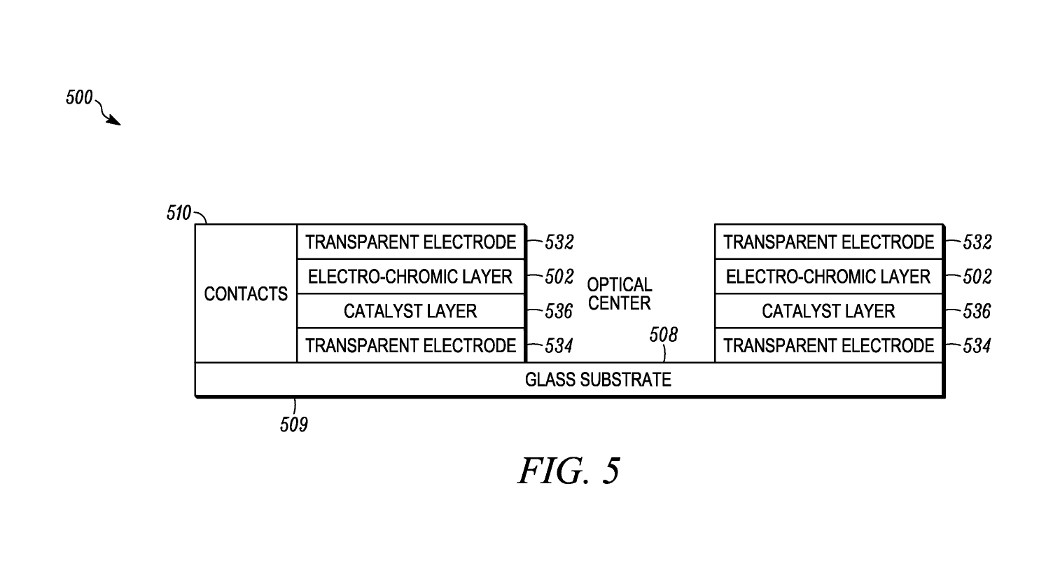

FIG. 5 depicts a side view of an embodiment of a controlled material aperture structure 500 having a layer of an electro-chromic material 502 such as a switchable mirror material. The center 508 of the electro-optical iris may be formed by a non-active glass substrate 509. The layer 502 proximal the glass substrate 509 of electrically controlled material substantially surrounds the central window. As described above, the electro-chromic layer can be in segments so that there are varying degrees of adjustability for the aperture 500. To apply a voltage to the electro-chromic material or heat in the case of a thermally controlled material, two layers of transparent electrode 532 and 534 are shown. A catalyst layer 536 may be provided to improve the rate of switching between transparent and opaque (i.e., reflective) states of the mirror material. Palladium may be used as a catalyst. In another embodiment, the electro-chromic layer 502 may be replaced by a layer of thermally controlled material, and the catalyst layer 536 may be replaced by a layer that provides heat energy in response to a voltage applied across transparent electrodes 532 and 534. The contacts 510 are in communication with either digital or analog circuitry. Accordingly, the state of the electrically controlled material is controlled by an amplitude of a voltage or by addressing through digital gates.

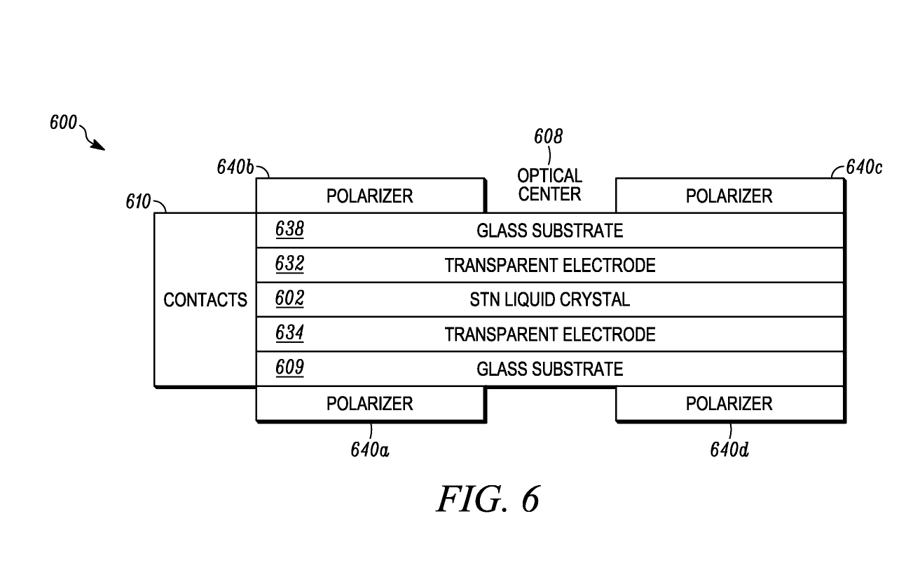

FIG. 6 depicts a side view of an embodiment of a controlled material aperture structure 600 having a layer of an electrically controlled material 602 such as a supertwist nematic (STN) material. The layer 602 proximal the glass substrate of electrically controlled material substantially surrounds the central window. The center 608 of the electro-optical iris may be formed by a non-active glass substrate 609. As described above, the electrically controlled material layer can be in segments so that there are varying degrees of adjustability for the aperture 600. To apply a voltage to the electrically controlled material or heat in the case of a thermally controlled material, two layers of transparent electrode 632 and 634 are shown. Another glass substrate 638 may be included. A polarizer layer 640a-d may be proximal to the glass substrates 609 and 638 as well. There may be no polarizer in the center of the iris which allows the central window or center 608 to have better transmittance. The contacts 610 are in communication with either digital or analog circuitry. Accordingly, the state of the electrically controlled material is controlled by an amplitude of a voltage or by addressing through digital gates.

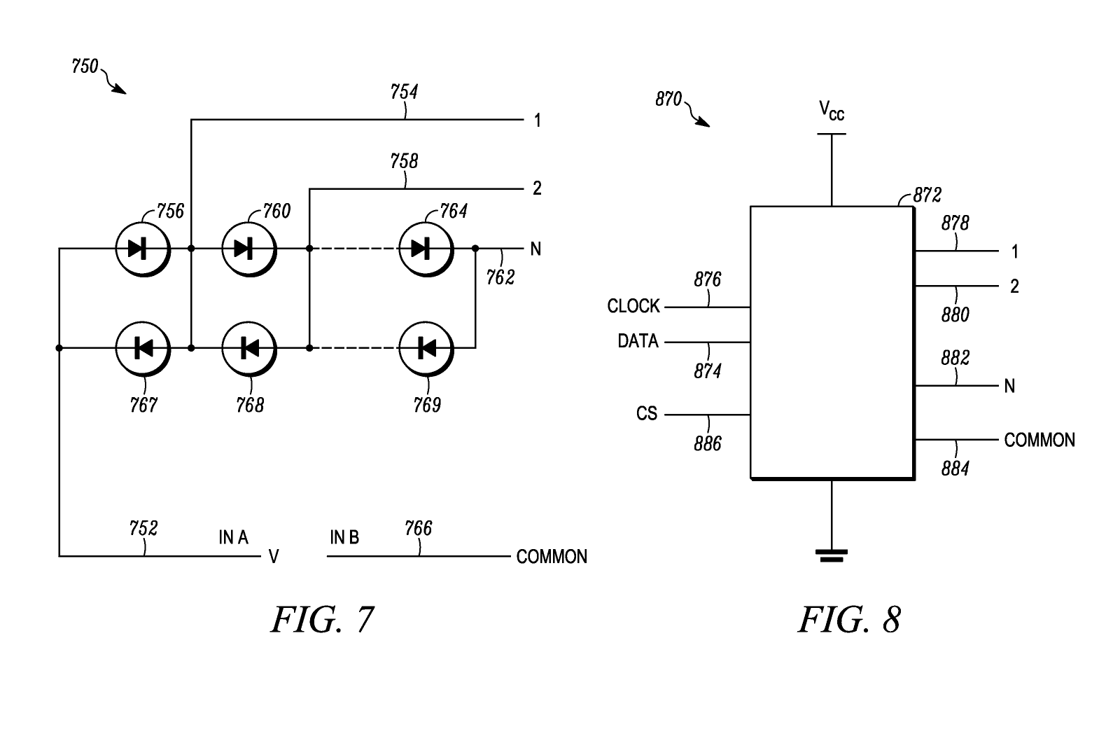

FIG. 7 shows an analog circuit 750 in communication with contacts 210, 310, 510 or 610 (see FIGS. 2, 3, 5 and 6) and with a voltage applying module 118 (see FIG. 1) that can be in communication with the automatic camera light and/or focus sensor module 116, and/or the input receiving module 117. When a sufficiently large positive voltage V is applied at 752, a voltage V−v_{drop} appears at 754, due to the voltage drop v_{drop} (approximately 0.7 volt) across the diode 756. When the voltage V is not large enough, the voltage appearing at 754 is substantially zero. In the same way, provided V is sufficiently large and positive, a voltage V−2 v_{drop} appears at 758 due to the voltage drop v_{drop} across each diode 756 and 760, and otherwise the voltage appearing at 758 is substantially zero. Operation of the circuit can continue in this manner, so that for an applied voltage V>Nv_{drop}, a voltage V−Nv_{drop} appears at 762 due to the voltage drop v_{drop} across each of the diodes 756, 760, . . . , 764. It is understood that 754 is coupled to ring 202 (see FIG.2), 758 is coupled to ring 204, and 762 is coupled to ring 206. Common 766 is coupled to a common electrode that is underneath rings 1, 2, . . . , N 202, 204, and 206. Diodes 767, 768, . . . , 769 pass current in the opposite direction to diodes 756, 760, . . . , 764, respectively, to allow both positive and negative voltages to drive the rings 202, 204, . . . , 206. In this way, application of an appropriate voltage V can control the opacity of the rings of the adjustable camera iris apparatus 200.

FIG. 8 shows a digital circuit 870 in communication with contacts 210, 310 510 or 610 (see FIGS. 2, 3, 5 and 6) and with a voltage applying module 118 (see FIG. 1) that can be in communication with the automatic camera light and/or focus sensor module 116, and/or the input receiving module 117. The digital circuit 870 may include a decoder chip 872. Digital data input 874 applied to the chip 872 is decoded in response to a clock signal 876, so that one or more of the outputs 878, 880, . . . , 882 has a sufficient large voltage to drive one or more of the rings 202, 204, . . . , opaque, and the other outputs have voltages substantially equal to zero. The output values are maintained until a successive clock signal. It is understood that 878 is coupled to ring 202 (see FIG.2), 880 is coupled to ring 204, and 882 is coupled to ring 206. Common 884 is coupled to a common electrode that is underneath rings 1, 2, . . . , N 202, 204, and 206. CS pin 886 is a chip select used to enable the chip. In this way, application of appropriate digital data 874 can control the opacity of the rings of the adjustable camera iris apparatus 200.

The above-described non-mechanical or electro-optical camera iris includes a controlled material that is configured to change from substantially transparent to substantially opaque by changing the state of the electrically controlled material to effectively adjust the size of the central window of the iris. Accordingly, the described electro-optical iris would add little or no additional bulk to a small mobile communication device camera. Accordingly, manufacturers may be inclined to include electro-optical irises in particular, in cellular telephones to increase the range for the depth of focus and range for the sensed light over those cellular telephone cameras having no irises.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A camera iris apparatus comprising:
a central window of a substantially transparent glass substrate, the central window having a size; and
a layer of controlled material configured to change from substantially transparent to substantially opaque by changing the state of the controlled material, the layer of controlled material proximal the glass substrate and configured to limit the central window by effectively reducing the size of the central window when the controlled material is opaque.

2. The apparatus of claim 1, wherein limiting the central window includes circumscribing the central window by controlling an opacity of the controlled material.

3. The apparatus of claim 1, wherein the controlled material is configured to change from substantially opaque to substantially transparent by changing the state of the controlled material to effectively increase the size of the central window.

4. The apparatus of claim 1, wherein the controlled material comprises an electrically controlled material.

5. The apparatus of claim 4, wherein the state of the electrically controlled material is controlled by an amplitude of a voltage or by addressing through digital gates.

6. The apparatus of claim 1, wherein the controlled material is selected from the group consisting of: electrically switchable mirror material, polymer liquid crystal material, cholesteric liquid crystal material, twisted nematic liquid crystal material, and supertwist nematic liquid crystal material.

7. The apparatus of claim 1, wherein the controlled material comprises a thermally controlled material.

8. The apparatus of claim 1, wherein the controlled material is opaque by reflection or absorption.

9. The apparatus of claim 1, wherein the layer of controlled material comprises a set of separately controllable areas.

10. The apparatus of claim 9, wherein the set of separately controllable areas substantially surrounds the central window, and the set has an ordering from inner to outer so that outer separately controllable areas in the set substantially surround inner separately controllable areas in the set.

11. The apparatus of claim 10, wherein the central window is substantially circular, and wherein the set of separately controllable areas comprises rings substantially concentric with the central window.

12. The apparatus of claim 11, wherein a ring has a width of approximately 0.2 millimeter.

13. The apparatus of claim 9, wherein the set of separately controllable areas comprises approximately polygon segments.

14. A method in a camera with a camera aperture having a size, the method for changing the size of the camera aperture, the camera aperture having a transparent window of predetermined size and having electrically controlled material proximal the transparent window, the method comprising:
applying a first voltage to the electrically controlled material so that the electrically controlled material is substantially transparent so that size of the aperture is that of the predetermined size; and
applying a second voltage to the electrically controlled material to change the state of the electrically controlled material so that the electrically controlled material is substantially opaque to limit the size of the aperture to less than the predetermined size to realize an aperture adjustment.

15. The method of claim 14, wherein the first voltage is about zero.

16. The method of claim 14, wherein the electrically controlled material is configured to circumscribe a central area of the transparent window.

17. The method of claim 14, wherein the electrically controlled material is configured to change from substantially opaque to substantially transparent by changing the state of the controlled material to effectively increase the size of the central area and realize an aperture adjustment.

18. The method of claim 14, wherein applying a voltage comprises:
controlling the electrically controlled material by an amplitude of a voltage or by addressing through digital gates.

19. The method of claim 14, wherein the controlled material is selected from the group consisting of electrically switchable mirror material, polymer liquid crystal material, cholesteric liquid crystal material, twisted nematic liquid crystal material, and supertwist nematic liquid crystal material.

20. The method of claim 14, wherein the controlled material is opaque by reflection or absorption.

21. A camera having an adjustable aperture comprising:
a central window of a substantially transparent glass substrate, the central window having a size; and
a layer proximal the glass substrate of electrically controlled material that substantially surrounds the central window,
wherein the controlled material is configured to change from substantially transparent to substantially opaque by changing the state of the electrically controlled material to effectively adjust the size of the central window to form the adjustable aperture.

22. The camera of claim 21, wherein the controlled material is configured to change from substantially opaque to substantially transparent by changing the state of the electrically controlled material to effectively increase the size of the central window.

23. The camera of claim 21, further comprising:
an analog circuit configured to apply a voltage to the electrically controlled material to effectively change the size of the central window.

24. The camera of claim 21, further comprising:
a digital circuit configured to apply a voltage to the electrically controlled material to effectively change the size of the central window.

25. The camera of claim 21, wherein the layer of controlled material comprises a series of separately controllable areas.
